(19) United States
(12) Patent Application Publication
(10) Pub. No.: US 2009/0094743 A1
(43) Pub. Date: Apr. 16, 2009

(54) MATTRESS

(75) Inventors: Makoto Tanaka, Tokyo (JP); Akira Nishimura, Tokyo (JP); Yumiko Mori, Tokyo (JP)

Correspondence Address: DARBY & DARBY P.C., P.O. BOX 770, Church Street Station, New York, NY, 10008-0770, US

(73) Assignee: PARAMOUNT BED CO., LTD, TOKYO (JP)

(21) Appl. No.: 12/093,696

(22) PCT Filed: Aug. 22, 2006
(86) PCT No.: PCT/JP2006/316413

§ 371 Date: Oct. 28, 2008

(30) Foreign Application Priority Data
Feb. 28, 2006 (JP) 2006-051623

(51) Int. Cl. A61G 1/00

(52) U.S. Cl. 5/81.1 T; 5/625

(57) ABSTRACT

The object is to provide a mattress that can be used as a stretcher when a disaster occurs and can also be used as an ordinary mattress when it is not used as a stretcher.

This invention proposes a mattress 1 formed by covering a padding with a covering material, characterized in that the covering material 3 has grip portions 4 fixed to the longitudinal edges near the corners of the mattress, that the ends on one side of multiple fastening belts 6 are fixed to both the longitudinal edges, that stowing portions 7 for stowing the fastening belts are provided, and that fastening members 9 are fixed at the ends on the other side of the fastening belts.

### TECHNICAL FIELD

The present invention relates to a mattress used mainly in hospitals, other medical facilities, elderly health-care facilities, etc.

### BACKGROUND ART

In cases where disasters such as fires and earthquakes occur in hospitals, other medical facilities, elderly health-care facilities, etc., stretchers are often used to manually carry people who cannot take refuge by themselves such as patients unable to walk and bedridden patients, to safe places for evacuation. In such cases, if elevators stop, those people must be carried through stairways.

These evacuation activities include the work of transferring each patient from the bed to a stretcher and the work of carrying the patient placed on the stretcher to a safe place. In general, 2 to 4 persons are necessary for carrying one patient by means of a stretcher to a safe place.

For the purpose of quickly performing such evacuation work with less manpower, for example, Patent Document 1 proposes a stretcher comprising a cushiony mattress. The stretcher of Patent Document 1 comprises a cushiony bendable mattress having cylindrical holding portions along the longitudinal edges of the mattress on both sides, with a shoulder belt inserted through each of the cylindrical holding portions; the shoulder belts extending from the respective ends of the cylindrical holding portions provided along both the longitudinal edges of the mattress are connected with each other to form loops at both the ends in the longitudinal direction; multiple fastening belts with their ends on one side fixed to both the longitudinal edges are disposed to oppose each other and lie in the transverse direction of the mattress, with intervals kept between them in the longitudinal direction of the mattress; and buckles are fixed as fastening members to the ends on the other side of the fastening belts opposing each other.

According to Patent Document 1, the stretcher with the above constitution can be compactly stowed and can be used to efficiently and easily carry a person, and further since it is cushiony, even if the stretcher with a patient on it is carried and placed on the ground, etc. to wait for any further action, the patient can remain comfortable on the stretcher.

### Patent Document 1: JP6-21466Y

### DISCLOSURE OF THE INVENTION

### Problem to be Solved by the Invention

The abovementioned stretcher of Patent Document 1 uses a mattress, but it is not supposed at all that when the stretcher is not used as a stretcher, the stretcher is used as a mattress on which a person can lie. That is, since it “can be compactly stowed,” it is destined to be stored in any place while it is not used as a stretcher.

If this stretcher is used as an ordinary mattress while it is not used as a stretcher, the shoulder belts and fastening belts exposed outside the mattress may disturb the patient, elderly person or the like using the mattress when he/she leaves from the bed, since he/she may be caught by the belts and fall down. Further, in the case where the bed is an electric bed, when the bed bottom is raised, lowered or tilted, the belts may be caught in a mechanical member, to prevent the bed movement or to damage the mattress inconveniently. After all, the stretcher cannot be used as an ordinary mattress.

The present invention has been created in view of the above situation. The object of this invention is to provide a mattress that can be used as a stretcher when a disaster occurs and can also be used as an ordinary mattress when it is not used as a stretcher.

### Means for Solving the Problem

To solve the abovementioned problem, this invention proposes a mattress formed by covering a padding with a covering material, characterized in that the covering material has grip portions fixed to the longitudinal edges near the corners of the mattress, that the respective ends on one side of multiple fastening belts are fixed to both the longitudinal edges, that stowing portions for stowing the fastening belts are provided, and that fastening members are fixed at the ends on the other side of the fastening belts.

Further, this invention proposes the abovementioned constitution, wherein each of the grip portions is a looped belt.

Further, this invention proposes the abovementioned constitution, wherein each pair of the fastening members is a buckle consisting of a male part and a female part to achieve fastening by resilient engagement between the engagement pieces of the male and female parts, and the male part is attached to each of the fastening belts fixed to one of the longitudinal edges while the female part is attached to each of the fastening belts fixed to the other longitudinal edge.

Further, this invention proposes the abovementioned constitution, wherein the padding is bendable.

Further, this invention proposes the abovementioned constitution, wherein the stowing portions can be opened and closed.

### EFFECTS OF THE INVENTION

In the mattress of this invention, multiple fastening belts are fixed to both the longitudinal edges, but since these fastening belts are folded and stowed in the stowing portions without being exposed outside the mattress, they neither disturb the user nor is obtrusive in appearance. On the other hand, each of the grip portions provided at the longitudinal edges near the corners is, for example, a looped belt or the like, the grip portions are not so dimensionally long and do not disturb the user like the handles provided along the longitudinal edges of an ordinary mattress.

Therefore, even if the mattress of this invention is used as an ordinary mattress, it does not happen that the patient, elderly person or the like using the mattress is caught by the fastening belts, to fall down, when he/she leaves from the mattress. Further, even if the bed is an electric bed, it does not happen that when the bed bottom is raised, lowered or tilted, the fastening belts are caught by a mechanical member, to prevent the bed movement or to damage the mattress inconveniently.

In the case where a disaster such as a fire or earthquake occurs while the mattress is used as an ordinary mattress, the stowing portions are opened to take out the fastening belts, and the respective pairs of fastening belts opposing each other in the transverse direction of the mattress are connected with each other using the fastening members, to stably secure the patient or the like on the mattress.

Therefore, in this state, a nurse or the like can hold the grip portions, to move the mattress, and the patient or the like stably secured on the mattress can be safety carried to a safe place.

In the above, if the padding is bendable, the above tight fastening operation can bend the mattress, to bring both the longitudinal edges closer to each other, thus deforming the mattress in U shape. In this case, since the U-shaped mattress embraces the patient or the like in cooperation with the multiple pairs of fastening belts, the patient can be safely and stably secured.

Therefore, in this state, a nurse or the like can hold the grip portions, to move the mattress, so that the patient or the like stably secured on the mattress can be safely carried to a safe place.

In the case where sufficient manpower is available, the mattress can of course be moved by multiple persons, but if the manpower is insufficient, one nurse or the like can hold appropriate grip portions, for examples, the grip portions near the head of the patient or the like stably secured on the mattress, to drag and move the mattress.

The mattress of this invention used as described above contains the padding necessary for use as an ordinary mattress. Therefore, even if there is an obstacle such as a level difference when the mattress is dragged and moved, the impact by the obstacle can be absorbed by the padding without displeasing the patient or the like stably secured on the mattress.

### BRIEF DESCRIPTION OF THE DRAWINGS

FIG. 1 is a perspective illustration showing the appearance of the mattress of this invention.

FIG. 2 is an expanded elevation showing an important portion of a longitudinal edge of the mattress of this invention.

FIG. 3 is an A-A line sectional view of FIG. 2.

FIG. 4 is an expanded elevation showing an operation in the portion of FIG. 2.

FIG. 5 is a perspective illustration of an important portion showing how the mattress of this invention is going to be used as a stretcher.

FIG. 6 is a perspective illustration showing a fastening member of a fastening belt on one side.

FIG. 7 is a perspective illustration showing a fastening member of a fastening belt on the other side.

FIG. 8 is a perspective illustration showing a corner of the mattress of this invention.

FIG. 9 is a perspective illustration showing how the mattress of this invention is used as a stretcher.

FIG. 10 is another perspective illustration showing how the mattress of this invention is used as a stretcher.

### MEANINGS OF SYMBOLS

1 mattress
2 padding
3 covering material
4 grip portion
6a, 6b fastening belt
7a, 7b stowing portion
8 fastener
9a, 9b fastening member
10a engagement piece
11 handle
12 patient or the like
13 nurse or the like

### THE BEST MODES FOR CARRYING OUT THE INVENTION

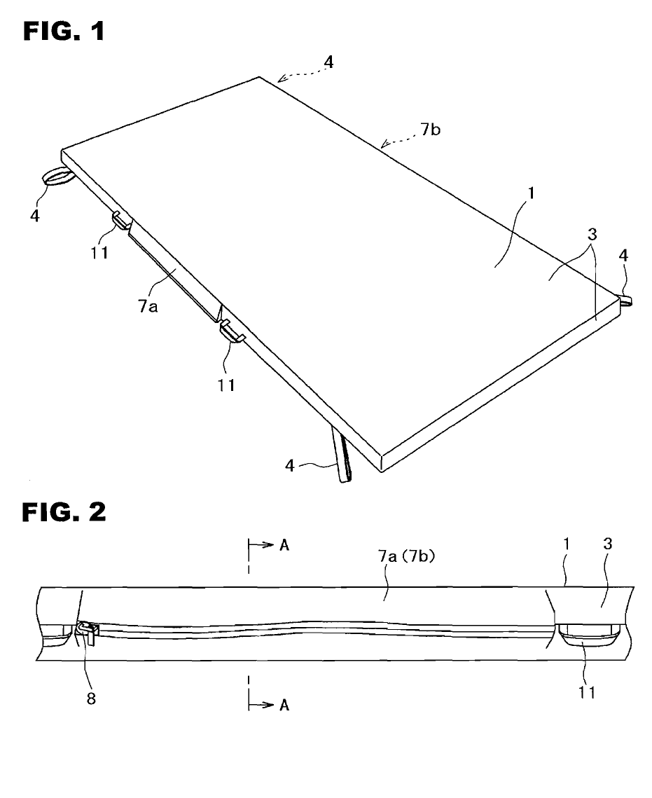

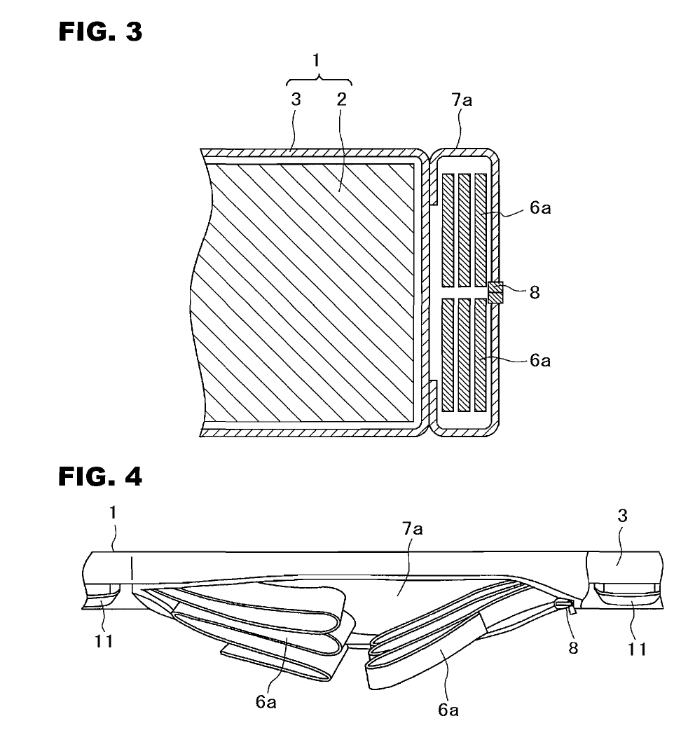

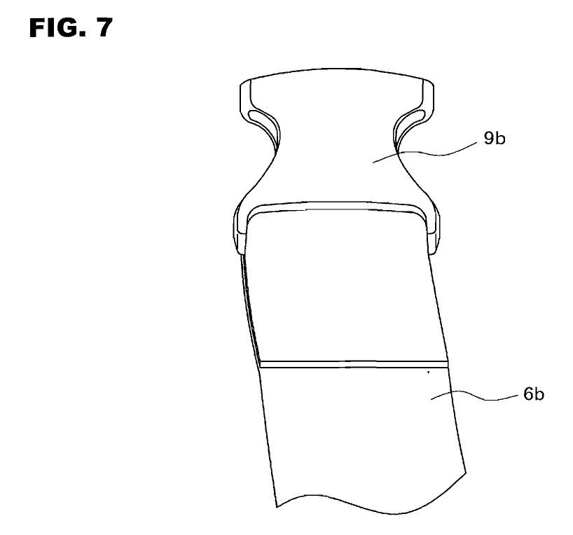

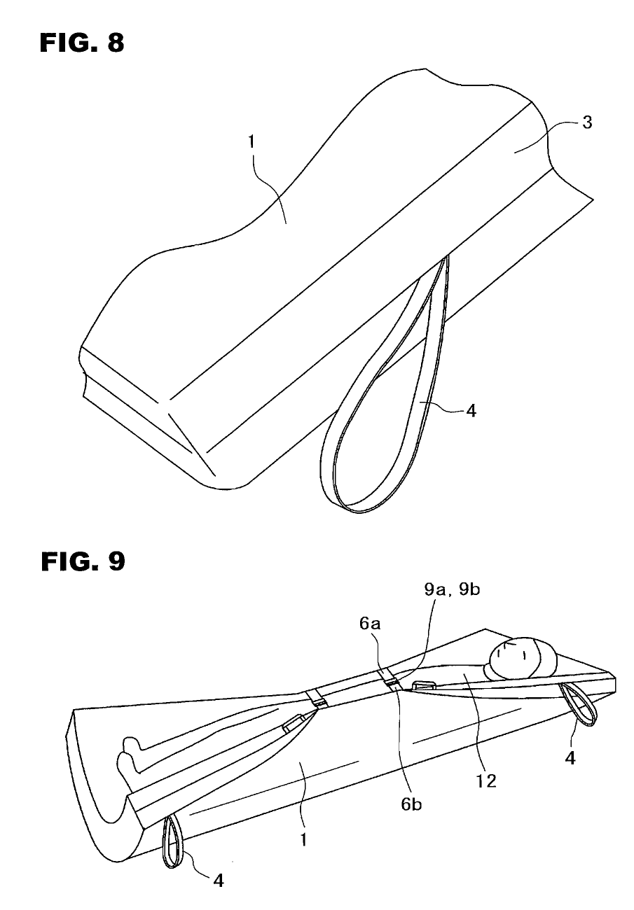

Embodiments of the mattress of this invention are explained below in reference to attached FIGS. 1-10.

In these drawings, symbol 1 denotes the appearance of a mattress. The mattress 1 is formed by covering a padding 2 with a covering material 3 like a usually used mattress. The padding 2 can be any appropriate padding used in an ordinary mattress, but it is desirable to use a bendable padding 2 in this invention.

In the mattress 1 of this invention, grip portions 4 are fixed to the covering material 3 at the longitudinal edges near the corners of the mattress. In this embodiment, each of the grip portions 4 is a looped belt.

Further, the ends on one side of multiple (two each in this example) fastening belts 6a and 6b are fixed to the covering material 3 at both the longitudinal edges of the mattress 1, with an interval kept between them in the longitudinal direction, and openable and closable stowing portions 7a and 7b for stowing respectively two fastening belts 6a or 6b are provided. Meanwhile, in the drawings, the parts of one of the longitudinal edges are indicated by subscript a, and the parts of the other longitudinal edge are indicated by subscript b.

In this embodiment, each of the stowing portions 7 can be opened and closed using a slide fastener, but instead of the slide fastener, a plane fastener such as a loop-hook fastener or snaps can also be used for opening and closing each stowing portion.

Meanwhile, contrary to the abovementioned embodiment wherein the stowing portions 7a and 7b can be opened and closed, in another embodiment, the openings of the stowing portions 7a and 7b can be closed by sewing in a relatively easy and simple manner, so that the sewn openings can be ripped to take out the fastening belts 6a and 6b and so that once the sewn openings of the stowing portions are ripped, they cannot be closed immediately.

Further, fastening members 9a and 9b are fixed at the ends on the other side of the respective fastening belts 6a and 6b, so that the respective fastening belts 6a and 6b provided as pairs in opposite to each other in the transverse direction of the mattress 1 can be connected with each other by the fastening members 9a and 9b. In this embodiment, either the fastening belts 6a or 6b (the fastening belt 6a in this case) can be adjusted in the length up to the fastening member [symbol] 9a.

In this embodiment, a pair consisting of a fastening member 9a and a fastening member 9b is a buckle consisting of a male part 9a and a female part 9b to achieve fastening by the resilient engagement between the engagement pieces of the male and female parts. On the male part 9a side, the fastening belt 6a can be adjusted in length as described above. Since the constitution of the buckle and the length adjustment are obvious, their further explanation is not made here.

Meanwhile, the length of the fastening belt 6a on the male part 9a side can be set at an appropriate length beforehand. So, the male part 9a can also be fixed at the other end of the fastening belt 6a with a predetermined length like the female part 9b, so that the length cannot be adjusted. That is, on the side of either the male part 9a or the female part 9b, the fastening belt 6a or 6b can be adjusted in length, or it is possible that neither the fastening belt 6a nor the fastening belt 6b can be adjusted in length.

In FIG. 1, each symbol 11 denotes a handle as attached to an ordinary mattress, to be used for carrying the mattress 1.

In the abovementioned constitution of this embodiment, the mattress 1 has multiple (two each in this case) fastening belts 6a and 6b fixed to both the longitudinal edges. These fastening belts 6a and 6b are folded and stowed in the respective stowing portions 7a and 7b, the openings of which are closed by fasteners 8, so that the fastening belts can be hidden inside without being exposed to outside the mattress 1 as shown in FIGS. 1 and 2. Thus, the fastening belts do not disturb the user and are not obtrusive in appearance. On the other hand, since the grip portions 4 attached to the longitudinal edges near the corners are not required to be dimensionally long as shown in FIG. 1, the grip portions are not disturbing the user like the handles 11 attached to the longitudinal edges of an ordinary mattress.

Therefore, even if the mattress 1 of this invention is used as an ordinary mattress, it does not happen that the patient, elderly person or the like using the mattress is caught by belts, to fall down, when he/she leaves from the bed, and even if the bed is an electric bed, it does not happen that when the bed bottom is raised, lowered or tilted, the fastening belts are caught by a mechanical member, to prevent the bed movement or to damage the mattress inconveniently.

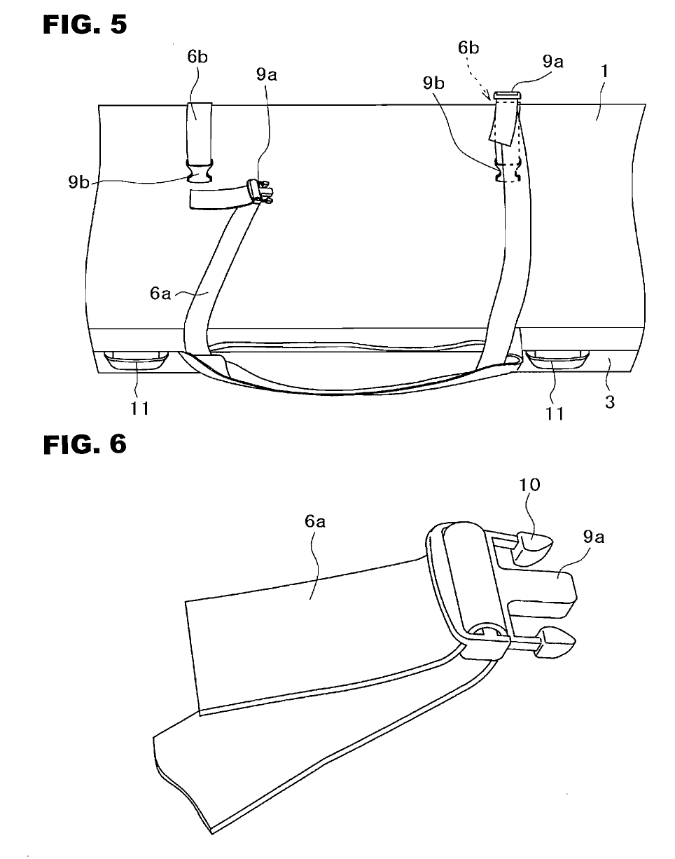

In the case where a disaster such as a fire or earthquake occurs while the mattress 1 is used as an ordinary mattress, the stowing portions 7a and 7b are opened to take out the fastening belts 6a and 6b, and as shown in FIG. 5, the fastening belts 6a and 6b in opposite to each other in the transverse direction of the mattress are connected with each other as pairs using the fastening members 9a and 9b. Then, the fastening belts 6a on one side are pulled to achieve tight fastening.

In this case, if the padding used is bendable, the above tight fastening operation can bend the mattress, to bring both the longitudinal edges of the mattress 1 closer to each other by the fastening belts 6a and 6b as shown in FIG. 9, thus deforming the mattress 1 in U shape. In this case, since the U-shaped mattress 1 embraces the patient or the like 12 in cooperation of the multiple (two in this case) pairs of fastening belts 6a and 6b, the patient or the like can be safely and stably secured.

Therefore, if the nurse or the like holds the grip portions 4, to move the mattress 1 in this state, the patient or the like 12 stably secured in the mattress 1 can be safely carried to a safe place.

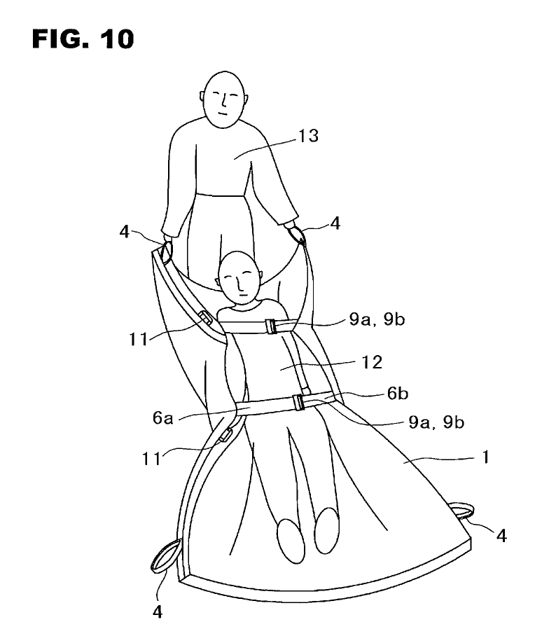

If there is sufficient manpower, the mattress 1 can be carried by multiple persons, but if the manpower is insufficient, one nurse or the like 13 can hold appropriate grip portions of the mattress, for example in the case shown in FIG. 10, the grip portions 4 on the head side of the patient or the like 12 stably secured on the mattress 1, to drag and move the mattress 1.

In this case, the mattress 1 of this invention contains the padding 2 necessary for use in an ordinary mattress. Therefore, even if there is an obstacle such as a level difference when the mattress is dragged and moved, the impact can be absorbed by the padding without displeasing the patient or the like stably secured on the mattress.

### INDUSTRIAL APPLICABILITY

Since this invention is as described above, the mattress used as an ordinary mattress by a person unable to take refuge by himself/herself such as a patient unable to walk or bedridden patient can be safely carried as a stretcher with the patient on it to a safe place for evacuation when a disaster occurs.

Further, in this invention, even one nurse or the like can use the mattress safely as a stretcher when a disaster occurs, and the padding cushiony as in an ordinary mattress absorbs and eases the impact caused when the mattress is dragged and moved, without displeasing the patient or the like.

1. A mattress formed by covering a padding with a covering material, characterized in that the covering material has grip portions fixed to the longitudinal edges near the corners of the mattress, that the respective ends on one side of multiple fastening belts are fixed to both the longitudinal edges, that stowing portions for stowing the fastening belts are provided, and that fastening members are fixed at the ends on the other side of the fastening belts.

2. A mattress, according to claim 1, wherein each of the grip portions is a looped belt.

3. A mattress, according to claim 1, wherein each pair of the fastening members is a buckle consisting of a male part and a female part to achieve fastening by resilient engagement between the engagement pieces of the male and female parts, and the male part is attached to each of the fastening belts fixed to one of the longitudinal edges while the female part is attached to each of the fastening belts fixed to the other longitudinal edge.

4. A mattress, according to claim 1, wherein the padding is bendable.

5. A mattress, according to claim 1, wherein the stowing portions can be opened and closed.
